(19) United States
(12) Patent Application Publication
(10) Pub. No.: US 2020/0143396 A1
(43) Pub. Date: May 7, 2020

(54) METHOD AND SYSTEM FOR SURVEY WEIGHTING

(71) Applicants: Michael Sadowsky, Chicago, IL (US); Keith Myers-Crum, Chicago, IL (US); David Shor, Chicago, IL (US); Allison Sullivan, Chicago, IL (US); Masa Aida, Chicago, IL (US)

(72) Inventors: Michael Sadowsky, Chicago, IL (US); Keith Myers-Crum, Chicago, IL (US); David Shor, Chicago, IL (US); Allison Sullivan, Chicago, IL (US); Masa Aida, Chicago, IL (US)

(21) Appl. No.: 16/181,631

(22) Filed: Nov. 6, 2018

(51) Int. Cl. G06Q 30/02; G06N 99/00; G06N 5/02

(52) U.S. Cl. CPC G06Q 30/0203; G06N 5/022; G06N 99/005

(57) ABSTRACT

A system and method for survey weighting is disclosed. According to one embodiment, a method comprises selecting key survey variables (KSVs) related to the survey; selecting microdata sources that represent a target population; training models using the KSVs as key survey variables; and collecting out-of-sample predictions. The method further comprises making predictions using the models; averaging the predictions over the target population; and generating survey weights using a calibration estimator.

### FIELD

The present disclosure relates in general to the field of computer software and systems, and in particular, to a method and system for survey weighting.

### BACKGROUND

### 1.1 Surveys and Weighting

Surveys are run to understand how a population feels about a specific topic. Since it is often infeasible to ask the whole population how they feel, a subset of that population provides responses that act as a stand-in for the responses of the whole population. Ideally this subset is representative of the larger population. However, this is often not the case. The primary reason weights are generated is to correct for potential biases in the sample of survey respondents that causes it to meaningfully differ from the population. Prior systems are unable to provide reliable weights that account for biases, such as nonresponse bias.

Perhaps the most prevalent concern is nonresponse bias, which occurs when people respond to a survey at differing rates in ways that are correlated to the responses of the survey question. When the sample differs from the population due to variable response rates in different subgroups (e.g., left-handed people are underrepresented in a political survey), but these subgroups do not meaningfully differ in their opinions (lefties probably do not have different political opinions than righties), then the differing response rates induce no bias in the estimate, and there is no need to correct for their nonresponse. Prior systems fail to correct for nonresponse from such subgroups, often decreasing the accuracy the estimate.

In addition to nonresponse bias, there are many reasons why a survey sample may meaningfully differ from the population it is meant to represent. For example coverage bias, which occurs when members of the population cannot be reached (e.g., the target population includes individuals without a phone, but the survey is conducted over the phone), is a common issue for surveys. The present system provides an improvement over prior systems and processes to address these biases.

### SUMMARY

A system and method for survey weighting is disclosed. According to one embodiment, a method comprises selecting key survey variables (KSVs) related to the survey; selecting microdata sources that represent a target population; training models using the KSVs; and collecting out-of-sample predictions. The method further comprises making predictions using the models; averaging the predictions over the target population; and generating survey weights using a calibration estimator.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The accompanying figures, which are included as part of the present specification, illustrate the various embodiments of the presently disclosed system and method, and together with the general description given above and the detailed description of the embodiments given below serve to explain and teach the principles of the present system and method.

FIG. 1 illustrates an exemplary process for generating the sample weights used to make an unbiased population estimate of a key survey variable, according to one embodiment.

FIG. 2 illustrates an exemplary system for generating survey weights using model-based target generation, according to one embodiment.

FIG. 3 illustrates an exemplary process for generating weights using model-based target generation, according to one embodiment.

FIG. 4 illustrates an exemplary plot of the log it, according to one embodiment.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

A system and method for survey weighting is disclosed. According to one embodiment, a method comprises selecting key survey variables (KSVs) related to the survey; selecting microdata sources that represent a target population; training models using the KSVs; and collecting out-of-sample predictions. The method further comprises making predictions using the models; averaging the predictions over the target population; and generating survey weights using a calibration estimator.

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### 1.2 how to Calculate Survey Weights

The present process finds weights that minimize nonresponse bias to allow the making of population inferences from a sample data set. At a high level, the process to obtain such weights uses survey data for one question, which is called a key survey variable (“KSV”). The KSV could be anything. (e.g., understanding a three-way political choice (“Trump vs. Clinton vs. other”), or a weighted estimate of a particular demographic characteristic (“how much money have you saved for retirement?”) from a sample population. A KSV is whatever characteristic to be estimated in a desired population segment. For a categorical KSV, an average proportion for each category (e.g., “48% support Clinton, 46% support Trump, 6% support someone else”) is desired. For a continuous KSV, an estimate is a simple weighted average (e.g., “the average retirement savings is $100,000 per household”).

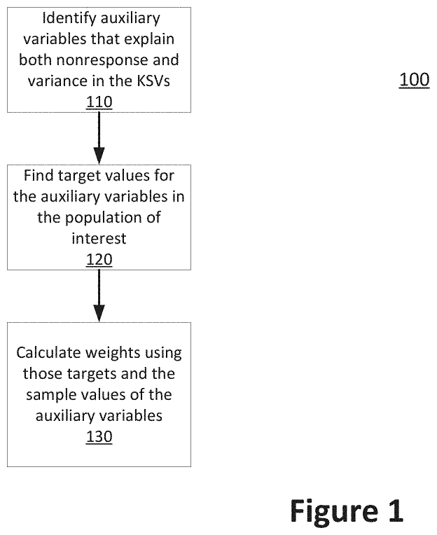

In addition to the KSV, other information about each respondent, which we call auxiliary variables, is collected or available from public databases. These may be demographic variables like age, gender, and race, but they may also be modeled quantities like partisanship. Additionally auxiliary variables can come from any survey question that can be compared to reference population values, such as how much time per week the respondent spends on the internet. Reference population values are quantities that can be validated for the population in question by a large, high quality survey. FIG. 1 illustrates an exemplary process 100 for generating the sample weights used to make an unbiased population estimate of a KSV, according to one embodiment.
1. Identify auxiliary variables that explain both nonresponse and variance in the KSV (110).
2. Find target values for the auxiliary variables in the population of interest (120).
3. Calculate weights using those targets and the sample values of the auxiliary variables (130).

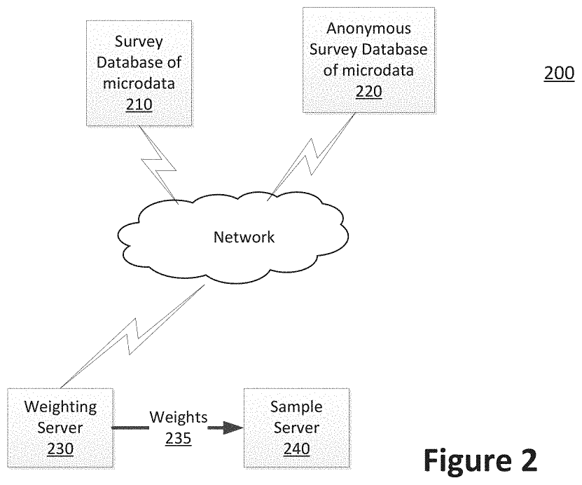

The details of each of these steps are below. According to one embodiment, the present method and system use a model-based process for steps 1 and 2 called model-based target generation (MBTG). FIG. 2 illustrates an exemplary system for generating survey weights using model-based target generation (MBTG) 200, according to one embodiment. MBTG builds a model of a KSV using covariates from a database of the population containing survey information 210 (also referred to as a “basefile” described in greater detail below) and additional population tables with anonymous survey database information 220. According to one embodiment, weighting server 230 executes the MBTG process using information from survey database 210 and anonymous survey database 220.

Specifically, anonymous survey database includes tables from the Current Population Survey; National Health Interview Survey; National Health and Nutrition Examination Survey; Survey of Income and Program Participation; American Community Survey; American Time Use Survey; Decennial Census; American National Election Studies; National Household Education Survey and the General Social Survey. This modeled prediction of a KSV forms a composite auxiliary variable, as its value is dictated by the covariates which form the inputs of the model. Out-of-sample cross-validation model predictions on our survey are taken as the auxiliary variables for respondents. The model is then used to make predictions on the population tables, the averages of which serve as the targets needed for step 2 (120).

The survey values of the auxiliary variables identified in step 1 and the population targets for those variables found in step 2 are plugged into a weight generating process (e.g., calibrate function from R's survey package). The present method and system calculates the smallest weights possible such that the weighted means of the survey's auxiliary variables match their population targets.

### 1.3 Survey Weights

Once sample weights are generated, the present method and system calculates the weighted mean of some variable in the sample (e.g., the key survey variable). The weighted mean provides a bias-corrected approximation for the population mean value of that same variable.

More explicitly, the weighted mean of a key survey variable y is calculated by multiplying the individual survey response yᵢ by the weight wᵢ of each survey respondent i. The result is then divided by the sum of the weights:

$$\frac{{\sum }_{i} {w}_{i} {y}_{i}}{{\sum }_{i} {w}_{i}} = {y}^{\hat{\_}} \qquad [ EQUATION 1 ]$$

The population mean, which we would like to know but can't directly measure, is denoted by y̅. The sample mean, which serves as a stand-in for the population mean, is denoted by \hat{y̅}.

### 1.4 An Example

To further explain weighting methodology, an example of nonresponse bias may relate to asking Chicagoans whether they support the Cubs or the White Sox. The KSV may be “Cubs support”. An unbiased estimate of a population's (i.e., all people in Chicago) opinion can be recovered from a sample that suffers from nonresponse bias. To do, this the known population values of a single auxiliary variable (“How far south of Madison Street do you live?”, in this case) are used as targets to construct simple poststratification weights for our sample. The weighted mean response of the survey provides an unbiased population estimate.

To simplify things a bit, assume half of Chicago lives north of Madison Street (the north side), and half-lives south of Madison Street (the south side). Everyone supports either the Cubs or White Sox, and most folks in both the north and south sides support the Cubs. More precisely, assume that the true population values are as follows: 80% of north siders support the Cubs, while 60% of south siders support the Cubs. Therefore the true population level of Cubs support amongst Chicagoans is 70% of the population.

Chicagoans are randomly surveyed until there are 1,000 completed surveys. Contactability is correlated with location in the city: north siders will be more likely to respond than south siders. Assuming, for the sake of simplicity, that location in Chicago is the only relevant variable for predicting one's survey response, a nonresponse bias is expected (e.g., 700 north siders and 300 south siders answer our survey). Also assume that exactly 80% of those north siders and 60% of south siders support the Cubs. Without weighting to correct the biased sample, the topline Cubs support is estimated as (700×0.8+300×0.6)/1000=0.74, or 74%.

Because the sample is not representative of our population, our unweighted estimate suffers a bias. A survey of this size would have a standard deviation of about 1.4% on this topline estimate, making the 4% bias quite significant. The present system can calculate weights to correct for the disproportionately north side sample. Once weights wᵢ for each respondent/are calculated, the mean value of our key survey variable y can be estimated in the population using equation 1 above.

Poststratification weights may be calculated as follows: the weight wᵢ of an individual in a given subgroup is found by dividing the true population proportion for that individual's subgroup by the sample proportion of that same subgroup. Given our population proportions of 0.5 north siders and 0.5 south siders, each south cider in our sample should get a weight of 0.5/0.3 and each north cider gets a weight of 0.5/0.7. Plugging these values into equation 1, the weighted topline estimate is obtained:

$$\frac{{\sum }_{i = 1}^{{N}_{w}} \frac{0.5}{0.3} \cdot 0.8 + {\sum }_{i = 1}^{{N}_{m}} \frac{0.5}{0.3} \cdot 0.6}{{\sum }_{i = 1}^{{N}_{w}} \frac{0.5}{0.7} + {\sum }_{i = 1}^{{N}_{m}} \frac{0.5}{0.3}} = 0.7 , \qquad [ EQUATION 2 ]$$

Where N_{w}=700 is the number of north siders in the sample and Nₘ=300 is the number of south siders. This gives us back a Cubs support of 0.7.

The example above is simplistic compared to a real survey. To develop accurate construct weights, the present method and system consider the following:
1. Typically many variables explain the variation in how someone responds to a survey, not just where the respondent lives.
2. Typically many variables explain the variation in whether someone responds to a survey, not just where the respondent lives.
3. The lists of variables in 1. and 2., are not known a priori.
4. The variables in 1. and 2. will have nontrivial correlations.
5. Often the population values for auxiliary variables are not readily available.

### 2. Standard Weighting

As explained above with respect to FIG. 1, the process for weighting a survey 100 is as follows:
1. Identify auxiliary variables that explain both nonresponse and variance in the key survey variable (KSV) (110).
2. Find target values for the auxiliary variables in the population of interest (120).
3. Calculate weights using those targets and the sample values of the auxiliary variables (130).

### 2.1 Identifying Auxiliary Variables for Weighting

The process of identifying an appropriate set of auxiliary variables for weighting searches for an optimal subset of many possible auxiliary variables that explains both the pattern of nonresponse and the variance in the key survey variable(s).

According to one embodiment, variable selection is accomplished by using the response itself as the key survey variable of a lasso estimator. In the case where the survey sample is pulled from a file/database where all respondents' auxiliary variables and response (or lack thereof) is known, the key survey variable of the lasso estimator is simply a binary: yᵢ [symbol] 0, 1, since it is known whether each person responded to the survey. In the case where the survey is conducted using a quota sample, poststratification cells are constructed using the candidate auxiliary variables, and each respondent's response probability is modeled using their poststratification weight. The log of this probability is then used as the target variable of the lasso regression estimator.

Poststratification cells are constructed from exhaustive and mutually exclusive categories, and they tell you what proportion of a population is in each of those subcategories. You use those cells and your sample proportions to calculate weights. The interior values of Table 1 below are examples of poststratification cells.

Once the model has been constructed, the lasso penalty is used to select a set of auxiliary variables. All 2- through G-way interaction terms are included between the G auxiliary variables as candidate auxiliary variables. This is equivalent to the most general poststratification scheme. This set of covariates is the set of independent variables for the lasso estimator.

The general problem of variable subset selection is a bias-variance tradeoff problem. Specifically, if all necessary explanatory variables are not included, the resulting model will end up being biased. However, as new variables are added into a model, the variables will increase the variance of the estimated coefficients. According to one embodiment, due to these competing pressures, there is some ideal sweet spot where just the right number of variables are included to balance the tradeoff between model bias and model variance. An appropriate set of auxiliary variables can reduce both the bias and variance of your survey estimates, as provided by the present method and system.

### 2.2 Population Target Values

Once the appropriate auxiliary variables are selected, the present method and system finds the population values of those variables. If using generic demographic auxiliary variables and the target population is simple (e.g., the general population of adults in the United States “genpop”), it may suffice to use the population statistics in data from the U.S. Census. For example, to weight to genpop where gender is the only relevant auxiliary variable, targets are 48.4% for men and 51.6% for women. However in cases where the population is not simple, such as voters in an upcoming election, target values are calculated using individual-level tables of data called microdata (e.g., basefile 210).

The basefile 210 contains hundreds of variables for adults in the United States, and the data comes from various sources. The basefile 210 also contains many modeled quantities, such as partisanship. To weight to a population like “Democrats in Illinois,” the present method and system calculates auxiliary variable target values using the partisanship score and state code from the basefile 210 to take weighted averages of the relevant auxiliary variables.

Additional sources of microdata include tables from the Current Population Survey (CPS) and the General Social Survey (GSS), both of which may be stored in anonymous survey database 220. The CPS is a joint project between the U.S. Census Bureau and the Bureau of Labor Statistics, and it includes many different questionnaires asked to households in the U.S. The GSS is conducted by the National Opinion Research Center (NORC), and it is a broad social survey that asks diverse questions, covering topics such as work, marriage, religiosity, psychological well-being, and education.

One complication of calculating targets using the CPS and GSS tables is that, unlike the basefile 210, survey respondents cannot be matched to the CPS and GSS tables because those tables only contain a tiny fraction of the U.S. population. Consequently, there are complications to building models that would enable the selection of more nuanced populations (e.g., “democrats in Illinois”) from which to calculate population target values.

### 2.3 Weight Estimation

Once the population target values t=(t₁, . . . , t_{g} . . . , t_{G}) of our auxiliary variables are determined, and the values of those same auxiliary variables xᵢ=(xᵢ₁, . . . , x_{ig}, . . . , x_{iG}) for each of our survey respondents are collected, the present method and system then calculates a weight for each respondent. Two approaches for constructing weights are poststratification and raking.

To construct poststratification weights, the joint distributions of all auxiliary variables are known. Raking, on the other hand, uses just the marginal distributions of the auxiliary variables. Let's consider a simple example where there are two auxiliary variables: gender and age. Assume a survey of 100 respondents, where there are 25 young women, 25 young men, 25 old women, and 25 old men. Assume the true population proportions are those shown in table 1.

TABLE 1

| | Men | Women | Totals |
|---|---|---|---|
| Young | 0.20 | 0.22 | 0.42 |
| Old | 0.27 | 0.31 | 0.58 |
| Totals | 0.47 | 0.53 | |

Poststratification weighting uses the interior values in Table 1 as targets for weighting. Raking uses the marginal totals in the bottom row and rightmost column in Table 1 as targets for weighting. To construct poststratification weights, the true population proportions of each group are divided by the sample proportions. Thus young men will get weights of 0.20/0.25, reducing the influence of each young man's response, while old women will get weights of 0.31/0.25, increasing their relative influence.

Raking uses an iterative process of adjusting the weights until the marginal totals have been matched. So in the present example, the rows are adjusted by multiplying each entry by (population row proportion)/(sample row proportion). So young people would get an initial weight of 0.42/0.50, and old people would get a weight of 0.58/0.50. The columns are adjusted the same way, multiplying the columns by (population column proportion)/(sample column proportion), where “sample column proportion” takes into account the adjustment in the previous step. The process proceeds until the marginal totals of the weighted sample matched those of the true population.

There are a number of tradeoffs between poststratification and raking that may motivate you to use one method over the other. For example, poststratification weights are simple to calculate on pen and paper and capture all the joint variance between difference variables. Weights from raking can't be as easily calculated, and they assume no interaction between the auxiliary variables. However, due to the curse of dimensionality, poststratification weights can quickly become infeasible: for G auxiliary variables with k categories each, the number of poststratification cells grows exponentially k^{G} in G, while the marginals used in raking scale linearly kG in the number of auxiliary variables. Additionally you may be constrained by the data you have available; for example, the Census may only publish marginal totals rather than the full joint distribution of the auxiliary variables you care about. According to one embodiment, with MBTG, the present system uses marginals (e.g. raking), and include additional poststratification targets, as well.

### 2.3.1 Calibration Estimators and Generalized Regression Estimator

The poststratification and raking methods described in the previous section are just two approaches that fall under the more general category of calibration weighting or calibration estimators. A calibration estimator finds a vector of respondent weights w=[w₁, w₂, . . . , wₙ] that minimizes L, the sum of distances D between w and a set of prior weights b (typically a vector of ones, in our case, but sample weights in the broader survey literature)

$$L = {\sum }_{i = 1}^{n} D ( {w}_{i} , {b}_{i} ) , \qquad [ EQUATION 3 ]$$

subject to the constraint that the weighted average of the G auxiliary variables matches the population average t_{g}:

$${t}_{g} = \frac{{\sum }_{i = 1}^{n} {w}_{i} {x}_{ig}}{{\sum }_{i = 1}^{n} {w}_{i}} ∀ g ∈ 1 , … , G . \qquad [ EQUATION 4 ]$$

This means that a calibration estimator provides the smallest weights possible such that the weighted averages of the sample auxiliary variables identically match the population expectations. This property of weighted sample estimates matching population values, expressed in equation 4, is known as calibration, hence the name “calibration estimator.”

According to one embodiment, the distance function in equation 3 is set to be the squared difference, D(wᵢ,bᵢ)=(wᵢ−bᵢ)². When this is the case, the above calibration estimator is mathematically equivalent to the generalized regression estimator, or GREG. GREG frames the problem of getting a weighted estimate ŷ GREG of a KSV as a linear regression. Weights can then be backed out of this regression estimator; these weights are identical to those extracted from the above optimization problem with D (wᵢ,bᵢ)=(wᵢ−bᵢ)²

### 3 Model-Based Target Generation

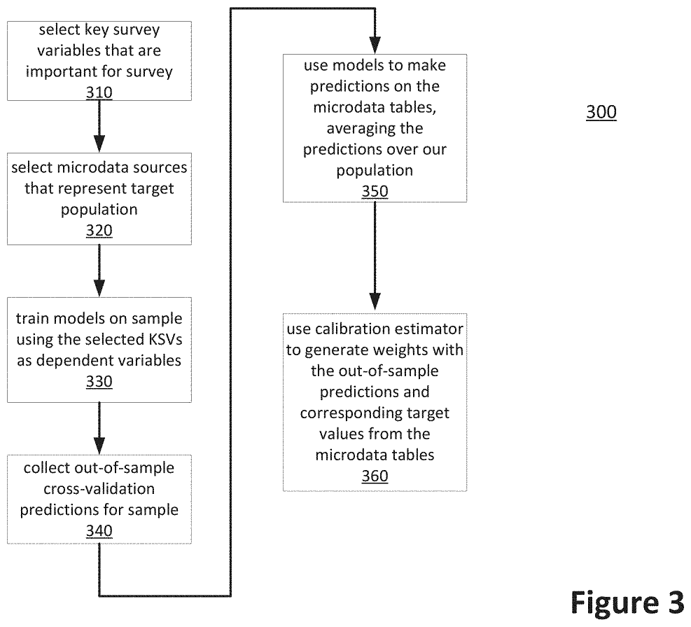

The present method is a model-based method for generating survey weighting targets from a large set of potential auxiliary variables. The present method is for model-based target generation, or MBTG. FIG. 3 illustrates an exemplary process for generating weights using MBTG 300, according to one embodiment. MBTG process 300 is as follows:
1. Pick a few survey KSVs that are most important for the survey. These KSVs are categorical, rather than continuous. (310)
2. Pick microdata sources that represent our target population. (320)
3. Train models on our sample using the selected KSVs as key survey variables (330) using classifiers, preferably multioutput classifiers. Examples of classifiers include random forests, logistic regression, and gradient boosted trees.
4. Collect out-of-sample cross-validation predictions for the sample (340). Stratified cross-validation is used to collect the out-of-sample scores. Cross-validation prediction assesses how the results of a statistical analysis will generalize to an independent data set. It is mainly used in settings where the goal is prediction, and one wants to estimate how accurately a predictive model will perform in practice. In a prediction problem, a model is given a dataset of known data on which training is run (training dataset), and a dataset of unknown data (or first seen data) against which the model is tested (called the validation dataset or testing set). The goal of cross-validation is to test the model's ability to predict new data that was not used in estimating it, in order to flag problems like overfitting and to give an insight on how the model will generalize to an independent dataset (i.e., an unknown dataset, for instance from a real problem). One round of cross-validation involves partitioning a sample of data into complementary subsets, performing the analysis on one subset (called the training set), and validating the analysis on the other subset (called the validation set or testing set). To reduce variability, in most methods multiple rounds of cross-validation are performed using different partitions, and the validation results are combined (e.g. averaged) over the rounds to give an estimate of the model's predictive performance.
5. Use those models to make predictions on information from the microdata tables 210 and 220, averaging the predictions over the population. The averaged predictions become population targets. (350)
6. Pass the out-of-sample predictions for our sample and their corresponding target values from the microdata tables to a calibration estimator to generate weights. (360)

According to one embodiment, k-fold cross-validation is used for the sample (340). The original sample is randomly partitioned into k equal sized subsamples. Of the k subsamples, a single subsample is retained as the validation data for testing the model, and the remaining k−1 subsamples are used as training data. The cross-validation process is then repeated k times, with each of the k subsamples used exactly once as the validation data. The k results can then be averaged to produce a single estimation. The advantage of this method over repeated random sub-sampling is that all observations are used for both training and validation, and each observation is used for validation exactly once. 10-fold cross-validation is commonly used, but in general k remains an unfixed parameter. For example, setting k=2 results in 2-fold cross-validation. In 2-fold cross-validation, we randomly shuffle the dataset into two sets d0 and d1, so that both sets are equal size (this is usually implemented by shuffling the data array and then splitting it in two). We then train on d0 and validate on d1, followed by training on d1 and validating on d0. When k=n (the number of observations), the k-fold cross-validation is exactly the leave-one-out cross-validation. In stratified k-fold cross-validation, the folds are selected so that the mean response value is approximately equal in all the folds.

At a high level, the present method uses models to pick the optimal combination of potential auxiliary variables necessary to explain the survey responses. And, unless nonresponse is driven by the key survey variables themselves the present model should be unbiased, even in the presence of nonresponse. So, in combination with detailed, individual-level data, the present method effectively uses a model to “ask” the population the selected KSVs. Any ways in which the sample's responses differ from the population are corrected by the calibration equations (equation 4). The weights 235 from process 300 guarantee that the sample estimates generated by sample server 240 agree exactly with the population estimates for the questions (KSVs) that are specified in step 310.

The components of system 200 include hardware components, including but not limited to a processor, memory (e.g., ROM, DRAM, etc.), storage (e.g., hard disk drive, solid state drive, external drives, etc.), network interfaces (e.g., LAN, WAN, system bus, etc.), as well as software such as an operating system, applications running on the operating system, etc.)

### 3.1 Picking KSVs for Weighting (310)

Surveys typically consist of many related questions, and when weighted, the method and system corrects for how respondents differ from a desired population, but only in ways that impact the responses to the questions. As a consequence, the present method and system picks a few questions for the model that are most important to the business problem.

According to one embodiment, all of the KSVs in a survey can be modeled and targets constructed for each KSV-value (e.g., a 3-way categorical question would have three corresponding targets). However, if too many targets are chosen, the variance of the estimated weights blows up, leading to inaccurately weighted means.

By default, if any chosen KSVs are missing entries, these null values are treated as a new category. For example, assume survey respondents responded to whether they voted for “Trump, Clinton, other, or none”. If all respondents answered this question, four binary categories would be created. However if some of our respondents skipped this question entirely, a fifth binary category would be created for the missing responses, leading to five KSV-values, each of which would generate one population target per source of microdata used for weighting.

### 3.2 Choosing Microdata Sources (320)

Microdata tables, such as the basefile 210 and/or a CPS table 220, are used to represent the population to which to apply weights 235. According to one embodiment, the present method may use three CPS tables, the GSS table, and a basefile to generate targets in weighting process. The three CPS tables may be specifically “cps arts”, “cps computer internet”, and “cps voting”. “Cps arts” has respondents' data about their consumption of the arts. “Cps computer internet” has respondents' data about computer ownership and internet access. “Cps voting” has data about voter behavior. Each of these tables have data from about 100,000 respondents. The Census and BLS provide weights for each entry in the tables, allowing for weighted averages that are representative of the U.S. population.

The GSS data contains weights generated by NORC to allow for weighted averages that are representative of the U.S. population. The GSS is conducted biennially, i.e., new results are released in even-numbered years.

According to one embodiment, a selection of columns is analyzed from each of the CPS and GSS tables for inclusion as covariates for models. The models as described above, are then used to predict on those same tables. Each table's predictions are then aggregated and used to represent genpop. Predicting on multiple microdata tables in MBTG provides a better result because each microdata table contains covariates that the other tables do not have.

For example, the GSS table contains a measure of religiosity that does not exist in the basefile 210 or CPS tables. So if the variance of the KSV and its nonresponse in the sample are partially explained by a respondent's religiosity, the model would only be able to detect and correct for the nonresponse bias by training on religiosity in the sample and then predicting on the GSS table, which has data on religiosity for genpop. If only the basefile was used to represent the population in this example, it would not be possible to correct for any bias caused by religiosity.

Therefore the microdata tables used in the present MBTG method determine which sources of nonresponse bias may be corrected.

The number of weighting targets increases linearly with the number of microdata sources. If one binary KSV for MBTG is chosen, by default two targets for each microdata source are generated: one target for the proportion of the sample with yᵢ=1, another target for the proportion with yᵢ=0. Each microdata source has its own model, since each microdata table contains unique covariates.

As MBTG does not match survey respondents back to the individuals in the CPS or GSS tables, the present method provides surveys that asks respondents the CPS and GSS questions to be used as model covariates.

3.2.1 Choosing Questions from the Microdata Sources

Survey questions that enable the inclusion of the CPS and GSS microdata tables in MBTG are chosen such that they may correlate with mechanisms that cause survey nonresponse. In particular, questions relate to social trust, socioeconomic status, and amount of time spent on the internet. Additionally, the questions include a diverse set of key survey variables to use as proxies for typical survey questions. For example, a key survey variable includes a response to the question of “who you voted for in the previous presidential election”, which is a proxy for “democrat vs. republican”.

Respondents are asked the proxy KSVs and the larger set of CPS and GSS candidate variables. The CPS/GSS question is identified whose aggregate value differed most between genpop and the survey respondents. A set of weights that are not MBTG is calculated using that question and age, sex, and race from the basefile 210 as auxiliary variables. This process is repeated, adding one new candidate CPS/GSS variable to the set of auxiliary variables, each time calculating the weighted averages of the KSVs. The final set of CPS and GSS questions are those which were present when the weighted averages of the proxy KSVs stabilized.

### 3.3 Microdata Model Training (330)

For each source of microdata, a multi-output model is built that predicts all chosen KSVs' values. Thus if m microdata tables are used, m models are built. In particular, a random forest classifier is used, which has three important properties. First, random forests enable multioutput modeling, which makes predicting on microdata tables a less computationally intensive process. Second, by virtue of the tree-splitting algorithm, random forests implicitly perform variable selection. Tree-splitting constructs a decision tree, where each split in the tree separates the data into the two sets which differ from each other as much as possible using only a single variable (e.g. age above 50 years old on one side of the split and below or equal to 50 years old on the other side).

Many data mining software packages provide implementations of one or more decision tree algorithms. Examples include Salford Systems CART, IBM SPSS Modeler, RapidMiner, SAS Enterprise Miner, Matlab, R (an open-source software environment for statistical computing, which includes several CART implementations such as rpart, party and randomForest packages), Weka (a data-mining suite that contains many decision tree algorithms), Orange, KNIME, Microsoft SQL Server, and scikit-learn (a machine learning library for the Python programming language).

Tree-based models also allow for higher order effects than linear models. For example, splitting twice on the same variable in a single tree enables second-order effects for that variable. More splits enable even higher order effects. This property also applies across multiple features, enabling crossfeature interactions in the model. In a weighting context, these higher order effects and interactions account for joint distribution effects, as would happen using poststratification.

As m multioutput random forests are fitted, cross-validation is performed allowing collection of out-of-sample predictions for the survey sample (340). Thus for m microdata tables and d unique KSV-values, m×d out-of-sample columns result that are appended to the survey data. Whereas in traditional weighting gender, age, or race columns may be used as auxiliary variables, these out-of-sample predictions are the auxiliary variables for which targets are calculated (350). The weights calculated in ensure that the weighted average of these out-sample-scores match our population targets (360).

### 3.4 Calculating Population Targets

### 3.4.1 Targets for Genpop

With one model per source of microdata and out-of-sample predictions for each of the m×d KSV-value/microdata pairings—where m is number of microdata sources and d is the number of unique KSV-values—target values are generated. At a high level, target values are generated by making predictions on the microdata tables, then taking the mean of these predictions over the population in the tables (350).

When making target predictions for genpop, predictions are made on the whole table for basefile 210, then the averages of each KSV-value column are taken. These averages form the targets that the out-of-sample prediction columns for the survey data match.

Genpop targets for the CPS and GSS microdata tables are similarly calculated. Because each of these tables is itself the result of surveys of the U.S. population, they contain weights calculated by the Census Bureau and NORC. Additionally, these tables may contain non-U.S. citizens or records with an age less than 18 years old, which are filtered out before target calculation. Like the basefile, an average of each predicted KSV-value for all adult U.S. citizens in each CPS and GSS table is taken. However, the provided weight column is used to take a weighted average.

### 3.4.2 Non-Genpop Targets

In some surveys, weighting to genpop is sufficient for our clients' needs. However in many consumer surveys and almost all political surveys, we're interested in more nuanced populations, which are called “universes”.

Given the breadth of available features and modeled quantities in the basefile 210, it is possible to isolate an universe. For example, if a population of interest is likely voters in Illinois in the 2018 mid-terms, the present method takes a weighted average of basefile records with state=‘IL’, using turnout score as the weight. Thus basefile targets are calculated by directly selecting (or modeling) the universe that exists in the basefile.

However, for the CPS and GSS microdata tables, that do not have modeled quantities (e.g., turnout score), the basefile 210 translates the genpop targets in the CPS and GSS microdata tables that were calculated in section 3.4.1 into targets for the desired populations. The out-of-sample predictions are denoted using the CPS and GSS microdata covariates in section 3.3 as ŷ_{md}^{s}, where md stands for one of the CPS or GSS microdata sources, and the superscript s indicates that these are the predictions on the survey sample. Let X_{bf}^{s} represent the basefile covariates of the survey sample. Note that the log it of a variable y ∈(0, 1) is given by

$$log ( \frac{y}{1 - y} )$$

and the inverse function of the log it is called the logistic.

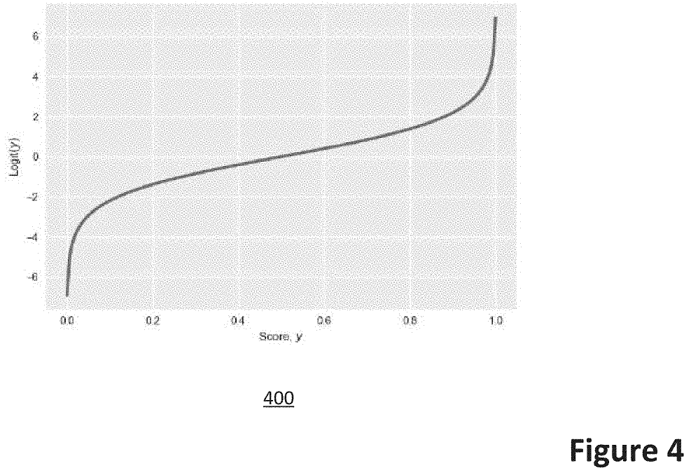

FIG. 4 illustrates an exemplary plot of the log it 400, according to one embodiment. The log it is a mathematical function used to turn probabilities (values between 0 and 1) into values that span the full range of the real numbers. The process for generating non-genpop targets for a CPS or GSS microdata source are the following:
1. Predict on the full microdata table md and calculate genpop targets t_{mdd}^{gp}, as described above in section 3.4.1.
2. Take the log it of the out-of-sample microdata predictions log it(ŷ_{md}^{s}).
3. Fit a regression model on the survey data to predict log it(ŷ_{md}^{s}) as a function of the basefile covariates X_{bf}^{s}.
4. Use this model to predict log it(ŷ_{md}) on the whole basefile. Take the logistic of these predictions, yielding \tilde{ŷ}_{md}^{bf} predictions (or rather “metapredictions”) on the entire basefile of the out-of-sample microdata predictions.
5. Use these meta-predictions to calculate targets in the basefile for genpop t_{md}^{gp} and for our universe t_{bf}^{uni}.
6. Finally, calculate the universe target for our CPS or GSS microdata sourcet_{md}^{uni} using log it-shifting, which uses t_{md}^{gp} and the basefile meta-prediction targets t_{bf}^{gp} and t_{bf}^{uni} from the previous step:

log it(t_{md}^{uni})≡log it(t_{md}^{gp})+log it(t_{bf}^{uni})−log it(t_{bf}^{gp}) [EQUATION 5]

This process uses basefile features to model the variance of the KSV in a non-basefile microdata table.

### 3.5 Generating Survey Weights

After calculating out-of-sample model predictions for survey respondents and population target values, survey weights are calculated. According to one embodiment, survey weights are generated using the calibrate function from R's survey package. R is a free software environment for statistical computing maintained by the R Foundation.

The calibrate function fits a calibration line or curve based on linear regression. The compute function takes in population marginals, which are our targets, and a formula. The formula encodes whether or not to account for interactions in our targets. By default we ignore these additional interactions, because the random forest models that generated our targets implicitly include interactions.

While the present disclosure has been described in terms of particular embodiments and applications, summarized form, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the scope of the present disclosure.

What is claimed is:

1. A method, comprising:
selecting key survey variables (KSVs) related to the survey;
training models using the KSVs;
collecting out-of-sample predictions;
making predictions using the models;
averaging the predictions over a target population; and
generating survey weights using a calibration estimator.

2. The method of claim 1, wherein the key survey variables are categorical.

3. The method of claim 1, further comprising selecting microdata sources that represent the target population, wherein the microdata sources include one or more of a current population survey (CPS) and a general social survey (GSS).

4. The method of claim 3, further comprising wherein the microdata sources are one or more of cps arts, cps computer internet, and cps voting.

5. The method of claim 1, wherein generating survey weights further comprises passing the out-of-sample predictions and target values to the calibration estimator.

6. The method of claim 1, wherein the model is a machine learning model.

7. The method of claim 1, wherein collecting out-of-sample predictions further comprises using stratified cross-validation to estimate how accurately the model will perform.

8. The method of claim 7, further comprising determining if there is overfitting with the model.

9. The method of claim 7, wherein using stratified cross-validation comprises partitioning a sample of data into a training subset and into a validation subset, performing analysis on the training subset, and validating the analysis on the validation subset.

10. The method of claim of claim 9, further comprising performing multiple rounds of stratified cross-validation using different subsets of the data, combining validation results over the rounds, and providing an estimate of the model's predictive performance.

11. The method of claim 1, further comprising calculating a log it of the out-of-sample predictions to translate target values for the target population to a different population.

12. A non-transitory computer readable medium containing computer-readable instructions stored therein for causing a computer processor to perform operations comprising:
selecting key survey variables (KSVs) related to the survey;
training a model using the KSVs;
collecting out-of-sample predictions;
making predictions using the model;
averaging the predictions over a target population; and
generating survey weights using a calibration estimator.

13. The non-transitory computer readable medium of claim 12, wherein the key survey variables are categorical.

14. The non-transitory computer readable medium of claim 12, further comprising selecting microdata sources that represent the target population, wherein the microdata sources include one or more of a current population survey (CPS) and a general social survey (GSS).

15. The non-transitory computer readable medium of claim 14, further comprising wherein the microdata sources are one or more of cps arts, cps computer internet, and cps voting.

16. The non-transitory computer readable medium of claim 12, wherein generating survey weights further comprises passing the out-of-sample predictions and target values to the calibration estimator.

17. The non-transitory computer readable medium of claim 12, wherein the model is a machine learning model.

18. The non-transitory computer readable medium of claim 12, wherein collecting out-of-sample predictions further comprises using stratified cross-validation to estimate how accurately the model will perform.

19. The non-transitory computer readable medium of claim 18, further comprising determining if there is overfitting with the model.

20. The non-transitory computer readable medium of claim 18, wherein using stratified cross-validation comprises partitioning a sample of data into a training subset and into a validation subset, performing analysis on the training subset, and validating the analysis on the validation subset.

21. The non-transitory computer readable medium of claim of claim 20, further comprising performing multiple rounds of stratified cross-validation using different subsets of the data, combining validation results over the rounds, and providing an estimate of the model's predictive performance.

22. The non-transitory computer readable medium of claim 12, further comprising calculating a log it of the out-of-sample predictions to translate target values for the target population to a different population.
